(19) United States
(12) Patent Application Publication
(10) Pub. No.: US 2007/0273601 A1
(43) Pub. Date: Nov. 29, 2007

(54) Signal transmission line for high resolution multi-media interface

(76) Inventor: Yu-Hong Hu, Tauyuan City (TW)

Correspondence Address: YU-HONG HU, 235 Chung-Ho, Box 8-24, Taipei, TW

(21) Appl. No.: 11/801,890

(22) Filed: May 11, 2007

(30) Foreign Application Priority Data
Mar. 10, 2006 (TW) 095203991

(51) Int. Cl. H01Q 9/16

(52) U.S. Cl. 343/792

(57) ABSTRACT

A signal transmission line for a high resolution multi-media interface, comprises a plurality of transmission lines; each of the transmission lines having three conductive wires; two conductive wires being twisted and the other conductive wire being an independent wire; wherein each conductive wire has a plurality of twisting points, the twisted points of two adjacent transmission lines are alternatively arranged. The signal transmission line further comprises an isolating sheet alternatively passing through the gaps between two adjacent transmission lines. Furthermore a connector with the signal transmission line has an upper cover, a lower cover, a joint and a bridge device; wherein the upper cover and lower cover encloses the joint, bridge device and the signal transmission line; one end of the signal transmission line has bared wires; the bridge device has a first connecting surface and a second connecting surface.

### FIELD OF THE INVENTION

The present invention relates to transmission lines, and particularly to a signal transmission line for a high resolution multi-media interface, wherein the signal transmission line is combined with the connector so that the signal transmission line has a flat shape. The twisting points of adjacent transmission lines are alternatively arranged so as to reduce the induction of the electromagnetic wave and the crosstalk and thus the conductive wires in the transmission lines can be well protected for avoiding destroy in bending.

### BACKGROUND OF THE INVENTION

HDMI (High-definition Multimedia Interface) is a transmission interface for a new generation multimedia devices which can be widely used in various commercial electronic devices. In this interface, the video and audio signals are integrated and the data is transferred by non-compressed high resolution digital transmission for transferring high density digital signals effectively with a maximum transmission speed of 5 Gbits/s. Other than transferring video signals of DVI, the audio signals of 8 channels are also transferred. It is a required interface in digital transmission.

However above transmission cannot avoid the external electromagnetic interference and unmatched impedance. For improving such problem, an improvement is disclosed, in that the HDMI transmission line has a cylindrical shape as illustrated in FIG. 1. The transmission line has a larger diameter and it is difficult to be bent with a great extent and thus it is easy to break or destroy in installation. Furthermore in the prior art, the twisting points of the wires in the transmission line are approximately aligned so as to have greater electromagnetic interference and crosstalk. Thereby, only the upper and lower sides of the transmission line are enclosed so that the effect of capacitance and inductance are greater and thus the signal decay is larger.

### SUMMARY OF THE INVENTION

Accordingly, the primary object of the present invention is to provide a signal transmission line for a high resolution multi-media interface, wherein the signal transmission line is combined with the connector so that the signal transmission line has a flat shape. The twisting points of adjacent transmission lines are alternatively arranged so as to reduce the induction of the electromagnetic wave and the crosstalk and thus the conductive wires in the transmission lines can be well protected for avoiding destroy in bending.

To achieve above objects, the present invention provides a signal transmission line for a high resolution multi-media interface, which comprises a plurality of transmission lines; each of the transmission lines having three conductive wires; two conductive wires being twisted and the other conductive wire being an independent wire; wherein each conductive wire has a plurality of twisting points, the twisted points of two adjacent transmission lines are alternatively arranged. The signal transmission line further comprising: an isolating sheet alternatively passing through the gaps between two adjacent transmission lines. Furthermore a connector with the signal transmission line has an upper cover, a lower cover, a joint and a bridge device; wherein the upper cover and lower cover encloses the joint, bridge device and the signal transmission line; one end of the signal transmission line has bared wires; the bridge device has a first connecting surface and a second connecting surface; the first connecting surface have jointing spots for contacting the bared wires and the second connecting surface has joint spots for matching the terminals of the joint.

The independent wire is used as a ground wire; and the independent wire is a bared copper wire which is arranged aside the two twisted conductive wires.

The various objects and advantages of the present invention will be more readily understood from the following detailed description when read in conjunction with the appended drawing.

### BRIEF DESCRIPTION OF THE DRAWINGS

FIG. 1 is a cross sectional view of a conventional cylindrical transmission line.

FIG. 2A is a front schematic view about the transmission lines of the present invention.

FIG. 2B is a schematic cross sectional view of the signal transmission line of the present invention.

FIG. 3 is an exploded schematic view showing the combination of the transmission lines and connector according to the present invention.

FIG. 3A is an enlarged view of the first connecting surface and second connecting surface according to the present invention.

FIGS. 4 and 5 are elevational and lateral schematic views of FIG. 3 after assembly.

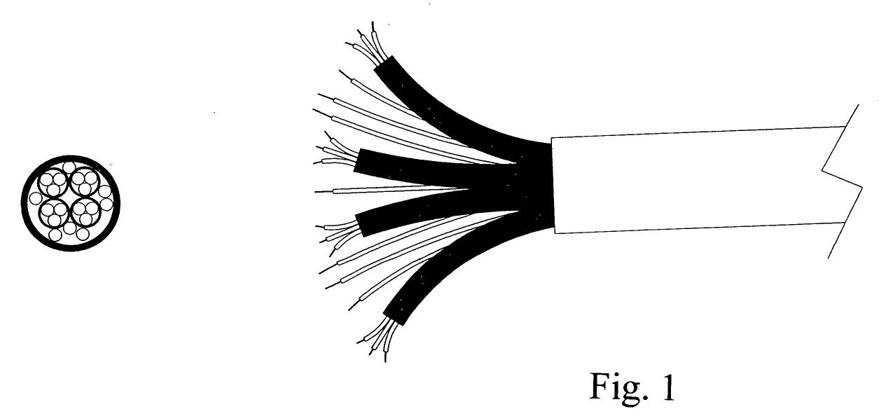

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

Referring to the attached drawings, the twisting wires of the present invention are illustrated. The present invention has the following elements.

A signal transmission line 1 includes a plurality of transmission lines 12a˜12d. Each of the transmission lines 12a˜12d has three conductive wires 122a˜122c. The conductive wire 122a and conductive wire 122b are twisted and the conductive wire 122c is an independent wire as a ground wire. Preferably, the conductive wire 122c is a bared copper wire. Or the conductive wires 122a˜122c are twisted as a transmission line 12a. The signal transmission line 1 further includes a control wire set 14. The transmission lines 12a˜12d may be for image transmission or audio transmission or as pulse lines for transmitting reference clocks in signal transmission.

The conductive wire 122a and conductive wire 122b for the transmission line 12a are twisted at points A, A+1, A+2, etc. The conductive wire 122a and conductive wire 122b for the transmission line 12b are twisted at points B, B+1, B+2, etc. In the present invention, the point sets A, A+1, A+2, etc. and point sets B, B+1, B+2, etc. are alternatively arranged so as to reduce the induction of electromagnetic wave and crosstalk in transmission. Similarly, the twisting points of two adjacent transmission lines are alternatively arranged (not aligned).

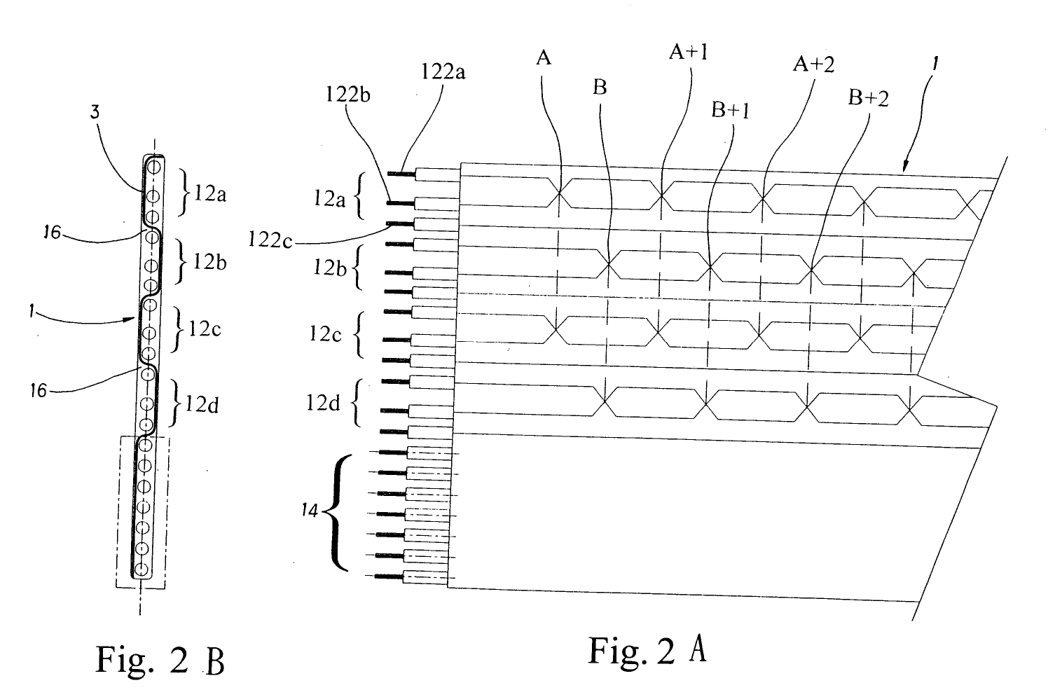

Referring to FIG. 2B, the cross sectional view of the present invention is illustrated. An isolating sheet is used to isolate different transmission lines 12a˜12d by alternatively passing through the gap 16 between two adjacent transmission lines 12a˜12d. Preferably, the isolating sheet is conductive aluminum foil 3 or tin foil or copper foil. In the drawing, the conductive aluminum foil 3 at the left side of the transmission line 12a passes through the gap 16 between transmission line 12a and transmission line 12b to the right side of the transmission line 12b, then the conductive aluminum foil 3 passes through the gap 16 between the transmission line 12b and transmission line 12c to the left side of the transmission line 12c. The process proceeds so as to isolate the electromagnetic interference. The conductive aluminum foil 3 is coated with a layer of conductive glue (not shown) so as to have preferred adhesion and thus the structure is stable.

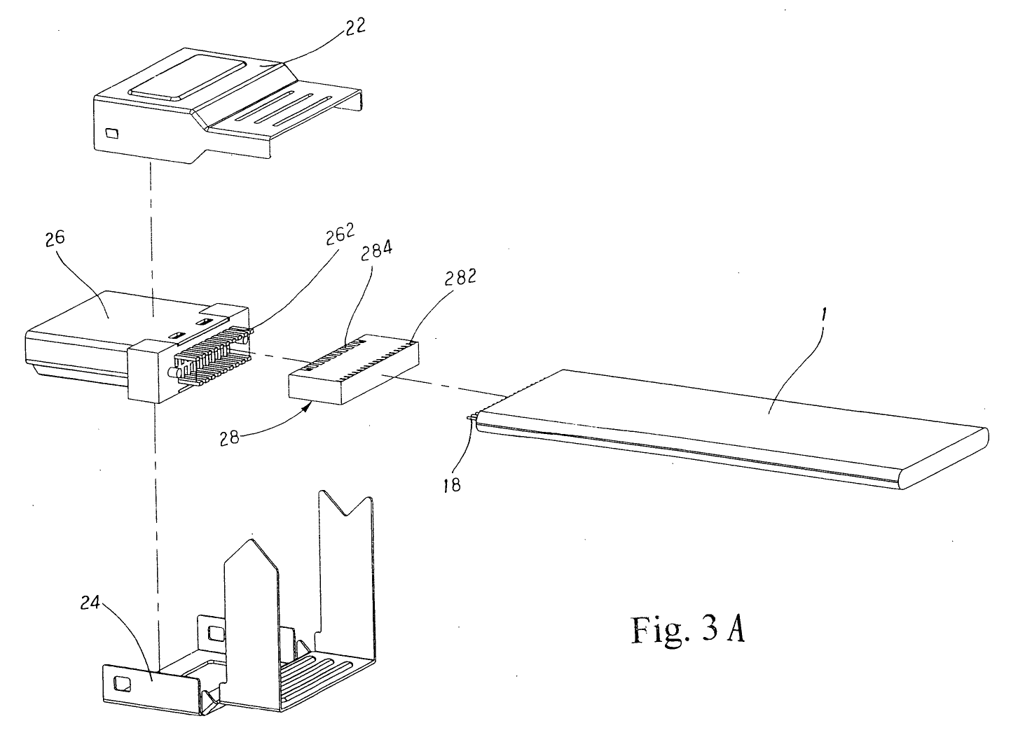

With reference to FIG. 3, the connector 2 of the present invention is illustrated. The connector includes an upper cover 22, a lower cover 24, a joint 26 and a bridge device 28. The upper cover 22 and lower cover 24 enclose the joint 26, bridge device 28 and the signal transmission line 1. One end of the signal transmission line 1 has bared wires 18. The bridge device 28 has a first connecting surface 282 and a second connecting surface 284. The first connecting surface 282 have jointing spots for contacting the bared wires 18 and the second connecting surface 284 has joint spots for matching the terminals 262 of the joint 26 (referring to FIG. 3A) so that the signals of the signal transmission line 1 can be transferred to the terminals 262 of the joint 26.

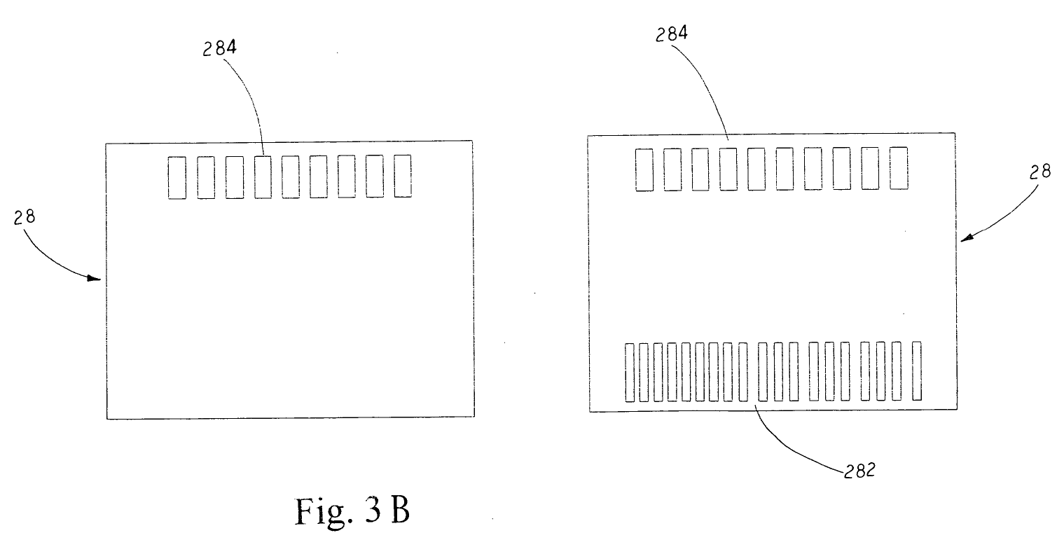

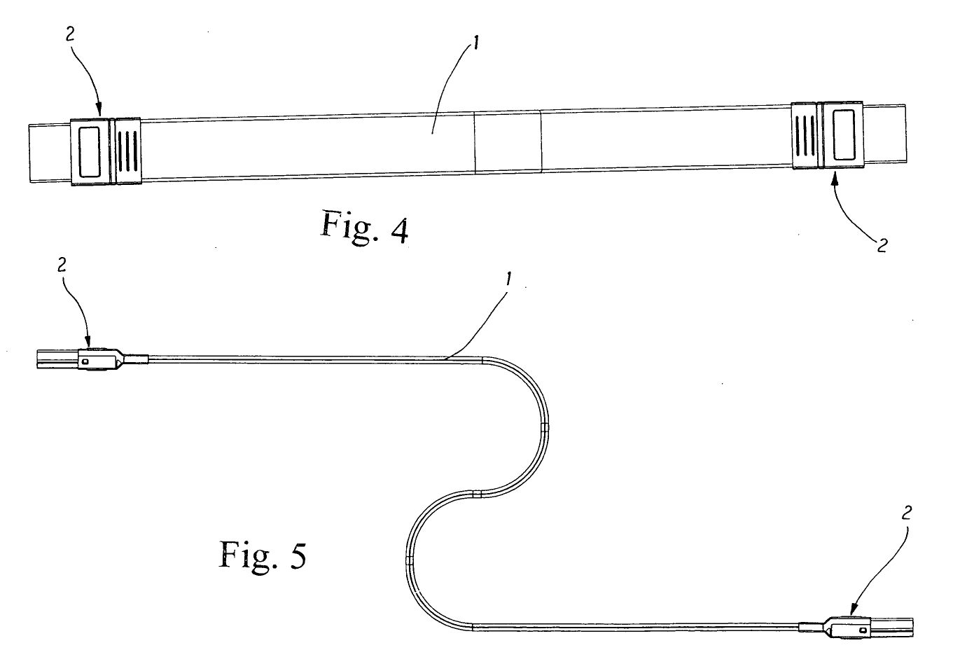

Referring to FIGS. 4 and 5, the assembly view of FIG. 3 is illustrated. The signal transmission line 1 is combined with the connector 2 so that the signal transmission line 1 has a flat shape. The twisting points of adjacent transmission lines 12a˜12d are alternatively arranged so as to reduce the induction of the electromagnetic wave and the crosstalk and thus the conductive wires 122a˜122c in the transmission lines 12a˜12d can be well protected for avoiding destroy in bending.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A signal transmission line for a high resolution multi-media interface, comprising:
a plurality of transmission lines; each of the transmission lines having three conductive wires; two conductive wires thereof being twisted and the other conductive wire being an independent wire;
wherein each conductive wire has a plurality of twisting points, the twisted points of two adjacent transmission lines are alternatively arranged.

2. The signal transmission line for a high resolution multi-media interface as claimed in claim 1, wherein twisted points of one conductive wire is spaced with an equal distance.

3. The signal transmission line for a high resolution multi-media interface as claimed in claim 1, wherein twisted points of one conductive wire is spaced with an unequal distance.

4. The signal transmission line for a high resolution multi-media interface as claimed in claim 1, wherein the independent wire is used as a ground wire; and the independent wire is a bared copper wire which is arranged aside the two twisted conductive wires.

5. The signal transmission line for a high resolution multi-media interface as claimed in claim 1, further comprising:
an isolating sheet alternatively passing through the gaps between two adjacent transmission lines.

6. The signal transmission line for a high resolution multi-media interface as claimed in claim 5, wherein the isolating sheet is one of a conductive aluminum foil or a conductive tin foil or a conductive copper foil.

7. The signal transmission line for a high resolution multi-media interface as claimed in claim 5, wherein the conductive aluminum foil is coated with a layer of conductive glue.

8. The signal transmission line for a high resolution multi-media interface as claimed in claim 5, wherein the independent wire is used as a ground wire; and is a bared copper wire which is arranged aside the two twisted conductive wires.

9. A connector with a signal transmission line of a high resolution multi-media interface comprising:
a signal transmission line having a plurality of transmission lines; each of the transmission lines having three conductive wires; two conductive wires being twisted and the other conductive wire being an independent wire; wherein each conductive wire has a plurality of twisting points, the twisted points of two adjacent transmission lines are alternatively arranged and
an upper cover, a lower cover, a joint and a bridge device; wherein the upper cover and lower cover encloses the joint, bridge device and the signal transmission line; one end of the signal transmission line has bared wires; the bridge device has a first connecting surface and a second connecting surface; the first connecting surface have jointing spots for contacting the bared wires and the second connecting surface has joint spots for matching the terminals of the joint.
